(19) United States
(12) Patent Application Publication
(10) Pub. No.: US 2013/0200585 A1
(43) Pub. Date: Aug. 8, 2013

(54) TRANSPORT CART

(71) Applicant: WASP, Inc., Glenwood, MN (US)

(72) Inventors: John H. Hoeper, Alexandria, MN (US); Stephen D. Lenarz, Glenwood, MN (US); Timothy A. Swenson, Glenwood, MN (US); Stuart J. Olstad, Plymouth, MN (US)

(73) Assignee: WASP, Inc., Glenwood, MN (US)

(21) Appl. No.: 13/762,903

(22) Filed: Feb. 8, 2013

Related U.S. Application Data
(60) Provisional application No. 61/596,325, filed on Feb. 8, 2012.

(51) Int. Cl. B62B 3/00

(52) U.S. Cl. CPC B62B 3/004
USPC 280/79.2; 29/428

(57) ABSTRACT

A transport cart that can be configured with an open carriage or a covered carriage. The open carriage configuration includes a carriage portion of unitary construction that defines a span portion and two end wall portions that extend perpendicular thereto. The covered carriage includes a cover portion that is substantially identical to the carriage portion, the cover and carriage portions being adapted to cooperate with each other to form the covered carriage configuration. In one embodiment, the carriage and cover portions are polymer based and formed from a rotational molding process.

### RELATED APPLICATIONS

This application claims the benefit of U.S. Provisional Patent Application No. 61/596,325 entitled “Transport Cart,” filed Feb. 8, 2012, the disclosure of which is hereby incorporated by reference herein in its entirety.

### FIELD OF THE INVENTION

The disclosed invention relates generally to towed vehicles, and more specifically to lightweight transport carts of modular construction.

### BACKGROUND

Baggage transport carts are utilized for transporting luggage between airport terminals and aircraft. These devices are typically made of metal, which is subject to corrosion (e.g., rust), thus requiring periodic maintenance (painting) in order to prevent structural damage and to maintain an acceptable appearance. Typical baggage transport carts usually feature metallic panels that are often subject to denting and scratching during the rigors of use. In addition to these shortcomings, the metal that comprises these carts is relatively heavy and expensive in comparison to other materials of construction.

A baggage transport cart that remedies the deficiencies of the standard metallic transport cart would be welcome.

### SUMMARY OF THE INVENTION

Various embodiments of the invention include a transport cart having a carriage fabricated primarily of a polymer. Polymer materials are corrosion resistant, resilient to avoid dents, and of homogenous material through its thickness to render scratches inconsequential. In addition, polymer carriages can be fabricated to be lightweight and inexpensive when compared with metallic counterparts.

Various embodiments of the invention provide for a transport cart that can be configured with either an open carriage or a covered carriage. The open carriage comprises a carriage portion that is integrally formed (i.e., of unitary construction). The covered carriage comprises a cover portion in addition to the carriage portion that is of substantially identical construction as the carriage portion. The substantially identical construction enables a supplier to fabricate the carriage and cover portions from the same tooling and/or to the same specifications, and to supply the carriage and cover portions from the same inventory.

Structurally, various embodiments of the transport trailer include a cover portion, a carriage portion operatively coupled with the cover portion, a front wheel assembly operatively coupled with the carriage portion, and a back wheel assembly operatively coupled with the carriage portion. The carriage portion and the cover portion can each include a span portion integrally formed with two opposing end wall portions, each of the end wall portions extending perpendicular to the span portion from a respective end of the span portion, and each including a distal end face distal to the span portion. In one embodiment, the span portion and opposing end wall portions are integrally formed and of a polymer material. The cover portion is in an inverted orientation relative to the carriage portion so that the distal end faces of the end wall portions of the cover portion are adjacent the distal end faces of the end wall portions of the carriage portion. In various embodiments, the cover portion and the carriage portion are identically formed. The cover portion and the carriage portion can be rotationally molded components. The distal end faces of the end wall portions of the cover portion and the distal end faces of the end wall portions of the carriage portion can also each include complementary structure that interlocks, the complementary structure being integrally formed with the cover portion and the carriage portion.

In certain embodiments, the carriage and cover portions are identically formed, but do not include complementary structures. In these embodiments, the transport trailer can further comprise interlocking coupling structure that mates with both the cover portion and the carriage portion, the interlocking coupling structure being separate from the cover portion and the carriage portion. The interlocking coupling structure can restrict relative motion between the cover portion and the carriage portion in a horizontal plane. The transport trailer can further comprise other means for securing the cover portion to the carriage portion and restricting relative motion between the cover portion and the carriage portion in a vertical direction. In one embodiment, the means for securing the cover portion to the carriage portion comprises fastening cleats mounted on a vertical face of the adjacent end wall portions to bridge the distal end faces of the adjacent end wall portions of the carriage portion and the cover portion, the fastening cleats being coupled with the adjacent end wall portions with fasteners. The means for securing the cover portion to the carriage portion can comprise a removable handle. In various embodiments, the cover portion of the transport trailer is coupled with the carriage portion with hinges. In one embodiment, the hinges are angled hinges to accommodate a non-horizontal hinge axis.

In another embodiment of the invention, a method of making a transport trailer comprises providing a carriage portion and a cover portion that are identically formed and each including a span portion integrally formed with two opposing end wall portions, each of the end wall portions extending perpendicular to the span portion from a respective end of the span portion, each of the end wall portions including a distal end face distal to the span portion. The cover portion is inverted relative to the carriage portion and positioned relative to the carriage portion so that the distal end faces of the end wall portion of the cover portion are adjacent the distal end faces of the end wall portion of the carriage portion. The cover portion is then coupled to the carriage portion. In one embodiment, the distal end faces of the carriage portion and the cover portion provided includes complementary structure that interlocks, the complementary structure being integrally formed with the cover portion and the carriage portion. Alternatively, coupling the cover portion to the carriage portion can include providing a coupling structure separately formed from the cover portion and the carriage portion, disposing the coupling structure between the adjacent of the distal end faces of the end wall portions of the carriage portion and the cover portion, the coupling structure restricting relative motion between the cover portion and the carriage portion in a horizontal plane. The method can also comprise providing a front wheel assembly and a back wheel assembly, and operatively coupling the front wheel assembly and the back wheel assembly to the carriage portion. In certain embodiments, the method further comprises providing a pair of hinges and hingeably attaching the cover portion to the carriage portion with the pair of hinges. The hinges provided can be angled hinges to accommodate a non-horizontal hinge axis. In one embodiment, the method further comprises securing the cover portion to the carriage portion with structure mounted on a vertical face of the adjacent end wall portions to bridge the distal end faces of the adjacent end wall portions of the carriage portion and the cover portion. The structure mounted on the vertical face of the cover portion and the carriage portion can comprise a fastening cleat.

### BRIEF DESCRIPTION OF THE DRAWINGS

FIG. 1 is a perspective view of an open carriage transport cart in an embodiment of the invention;

FIG. 2 is a perspective view of a covered carriage transport cart in an embodiment of the invention;

FIG. 3 is a front elevation view of the covered carriage transport cart of FIG. 2;

FIG. 4 is a perspective view of a carriage and/or cover portion of FIGS. 1-3;

FIG. 5 is a sectional view of the carriage and/or cover portion of FIG. 4;

FIG. 6 is a perspective isolation view of the cover portion in place over the carriage portion of the covered carriage transport cart of FIG. 2;

FIG. 7 is a perspective view of a covered carriage transport cart with shelf in an embodiment of the invention.

FIGS. 8A, 8B and 8C are a three-way orthographic projection of the covered carriage of FIG. 7;

FIGS. 9 and 10 are exploded isometric views of alternative covered portions with complementary structure in embodiments of the invention;

FIG. 11 is an exploded isometric view of an alternative covered portion without complementary structure in an embodiment of the invention;

FIG. 12 is an elevation view of a covered carriage transport cart with a hinged cover that hinges along a non-horizontal hinge axis in an embodiment of the invention;

FIGS. 12A and 12B are angled hinges utilized in the covered carriage transport cart of FIG. 12;

FIG. 13 is an alternative hinged covered portion in an embodiment of the invention;

FIG. 14 is the covered carriage of FIG. 6 with removable handles for securing the cover portion to the carriage portion in an embodiment of the invention;

FIGS. 14A-14D are sectional views of removable handles installed in the covered carriage of FIG. 14 in embodiments of the invention; and

FIGS. 15 and 16 depict undercarriage details in an embodiment of the invention.

### DETAILED DESCRIPTION

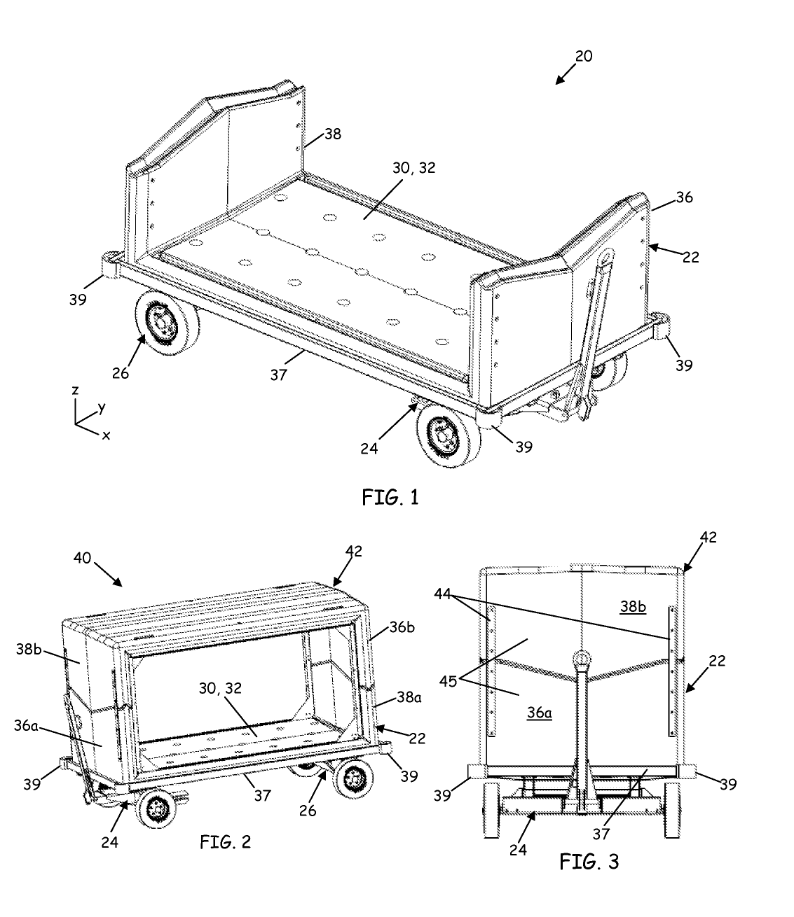

Referring to FIG. 1, an open carriage transport cart 20 is depicted in an embodiment of the invention. The open top transport cart 20 includes a carriage portion 22 operatively coupled to a front wheel assembly 24 and a back wheel assembly 26. The carriage portion 22 includes a span or bed portion 30 having a first major surface 32 and a second major surface 34 (FIG. 16), and two end wall portions 36 and 38 that extend perpendicular to the first major surface 32. In one embodiment, a frame 37 extends around the base of the carriage portion 22. The frame 37 can include bumpers 39 that cover the corners of the frame 37.

Referring to FIGS. 2 and 3, a covered carriage transport cart 40 is depicted in an embodiment of the invention. The covered carriage transport cart 40 comprises the same components as the open carriage transport cart 20, with the addition of a cover portion 42 that is operatively coupled to the carriage portion 22. To distinguish between the end walls 36 and 38 of the carriage and cover portions 22 and 42, the numerical reference suffixes “a” and “b” are adapted herein to designate the portions of the carriage and cover portions, respectively. In one embodiment, fastening cleats 44 are secured to vertical faces 45 of abutting end wall portions (e.g., the end wall portions 36a and 38b of FIG. 3) are secured to the covered carriage transport cart 40 with fasteners.

In operation, the open carriage transport cart 20 provides open access from both sides and the top, and is suitable for indoor use, fair weather outdoor use, or when inclement weather is of no consequence to the payload. The covered carriage transport cart 40 is suitable where some degree of protection is desired for the payload, or where the payload is to be veiled.

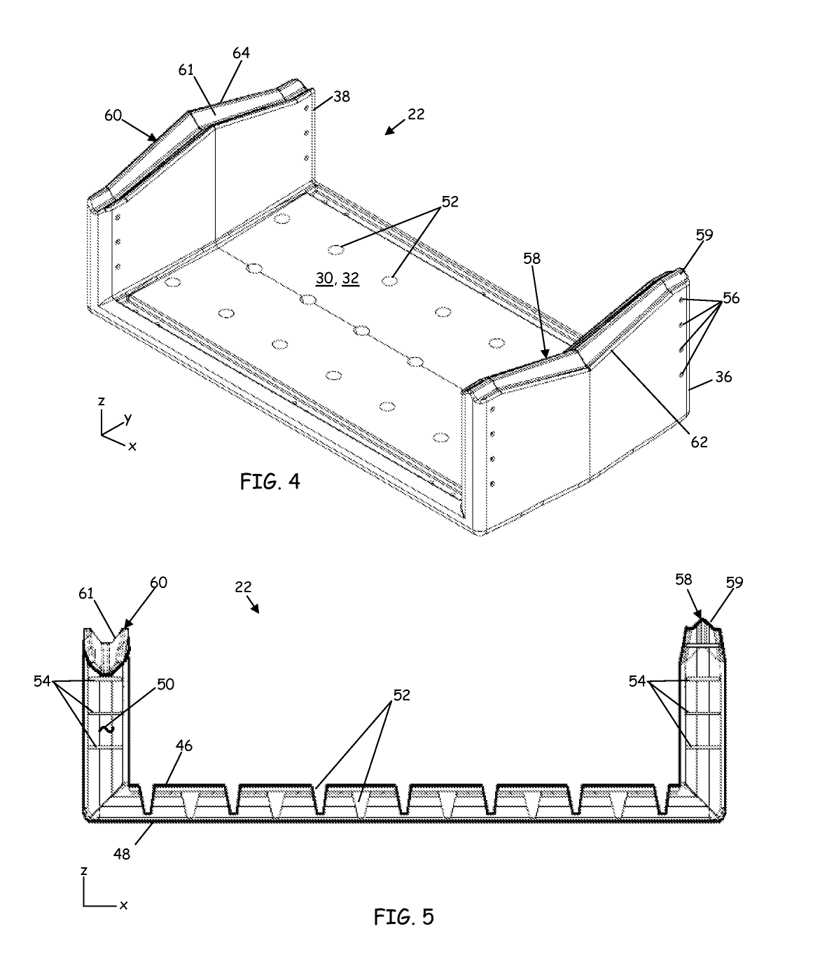

Referring to FIGS. 4 and 5, the construction of the carriage portion 22 is discussed in greater detail in an embodiment of the invention. In this embodiment, the span portion 30 and the two end wall portions 36 and 38 are integral, rotationally molded components having dual, opposing walls 46 and 48 that define an interior chamber 50. Indentations 52 can be provided that bridge at least part way between the opposing walls 46 and 48. Molded tubes 54 can also be integrally formed in the rotational molding process that bridge between the opposing walls 46 and 48 to define passageways 56 that pass through the end wall portions 36 and 38.

In one embodiment, the end wall portions 36 and 38 define distal end faces 58 and 60, respectively, each distal to the span portion 30. The distal end face 58 is depicted as defining a convex surface 59, while the distal end face 60 is depicted as defining a concave surface 61. In this embodiment, the convex surface 59 of distal end face 58 is dimensioned to mate within the concave surface 61 of the distal end face 60.

The distal end faces 58 and 60 can also define complex and complementary profiles when viewed in a direction normal to the end wall portions 36 or 38. In the depicted embodiment, the distal end faces 58 and 60 define V-shaped contours 62 and 64, respectively. In the depicted embodiment, the V-shaped contour 62 is oriented with the apex pointing downward and the V-shaped contour 64 is oriented with the apex pointing upward.

The carriage and cover portions 22 and 42 are identically formed, i.e., are fabricated to the same specifications (for example, from the same mold). The structural features of the carriage and cover portions 22 and 42, such as the convex surface 59 and concave surface 61 of the distal end faces 58 and 60, respectively, and the V-shaped contours 62 and 64, are referred to herein as “complementary” structure, i.e., adapted to interlock together so that, without the use of other structures, relative motion with respect to each other is restricted.

We note that while the discussion herein is directed to rotationally molded components, other forms of manufacture can be implemented with the invention. For example, and without limitation, the carriage and cover portions 22 and 42 can be fabricated by any number of processes, including but not limited to blow molding, extrusion molding, pour molding, overmolding or some combination thereof.

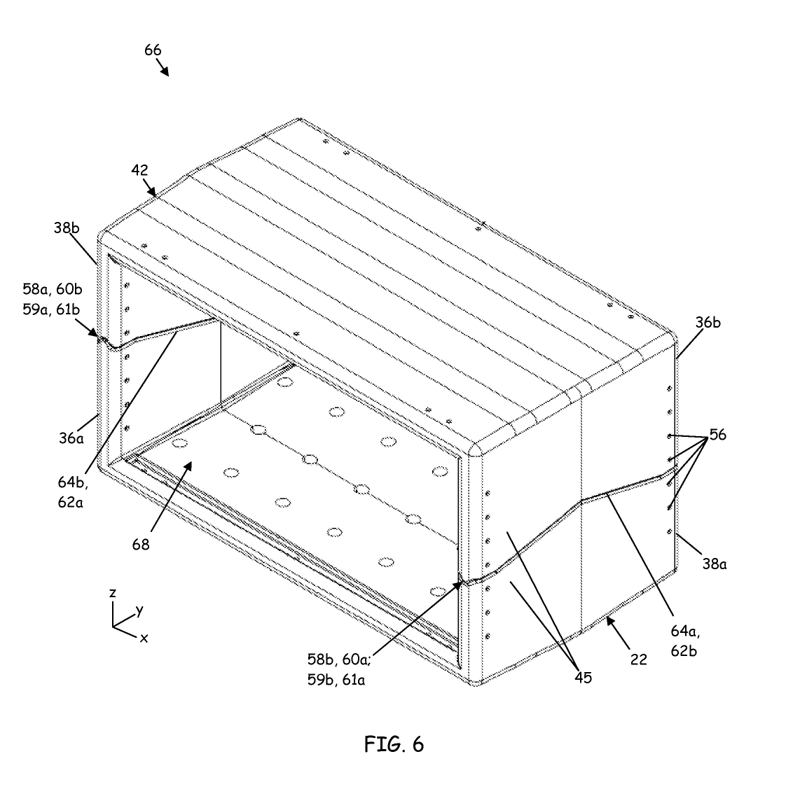

Referring to FIG. 6, a covered carriage assembly 66 comprising the cover portion 42 and the carriage portion 22 is depicted in an embodiment of the invention. In this embodiment, the carriage and cover portions 22 and 42 are substantially identical and cooperate to define an interior compartment 68. Again, to distinguish between the end walls 36 and 38 of the carriage and cover portions 22 and 42, the numerical reference suffixes “a” and “b” are adapted herein to designate the portions of the carriage and cover portions, respectively. Likewise, the distal end faces 58 and 60 and the V-shaped contours 62 and 64 of the respective carriage and cover portions 22 and 42 also have “a” and “b” suffixes to designate the portions of the carriage and cover portions, respectively.

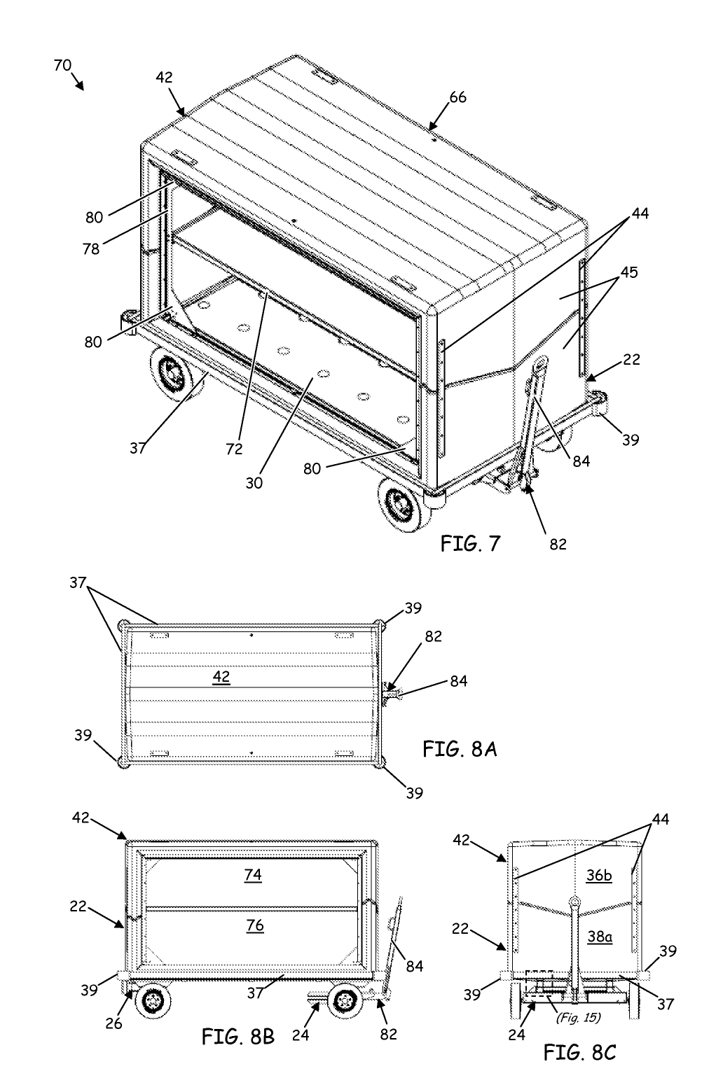

Referring to FIG. 7 and FIGS. 8A-8C, a completed assembly of a covered carriage transport cart 70 is depicted in an embodiment of the invention. In this embodiment, a shelf 72 divides the interior compartment 68 to define an upper and a lower compartment 74 and 76, respectively. In one embodiment, the covered carriage transport cart 70 includes brackets 78 mounted to the interior of the end wall portions 36 and 38. The brackets 78 may be mounted opposite the cleats 44, utilizing the same fasteners in the passageways 56 as the cleats 44 and providing a rigid surface for registration of the bolt head and nuts (not depicted). The brackets 78 may include gusseted corners 80 to provide additional strength to the covered carriage assembly 66. Appurtenances, such as sliding doors or curtains (not depicted), may be suspended from the brackets to facilitate closure of the covered carriage assembly 66.

In one embodiment, the front wheel assembly 24 includes a tow bar actuated brake assembly 82 that is designed to lock the axle of the front wheel assembly 24 when the tow bar 84 is in an upright position.

Functionally, the indentations 52 give strength to the span portion 30 by serving as spacers that maintain separation between the opposing walls 46 and 48 when span portion 30 is subject to a load. The molded tubes 54 are positioned to provide passage for bolts (not depicted) that attach the cleats 44 to the end walls 36 and 38.

The convex surface 59a of the distal end face 58a mates with the concave surface 61b of the distal end face 60b so that the two distal end faces 58a and 60b interlock; likewise for distal end faces 58b and 60a. The interlock caused by the mating convex and concave surfaces 59a, 61b and 59b, 61a of distal end faces 58a, 60b and 58b, 60a, respectively, provides stability between the carriage and cover portions 22 and 42 in the forward and aft directions (i.e., along the “x-axis” of FIG. 6).

The V-shaped contour 62a also cooperates with the V-shaped contour 64b to also provide an interlock; likewise for V-shaped contours 62b and 64a. The interlocking of the V-shaped contours 62a with 64b and 62b with 64a provides stability between the carriage and cover portions 22 and 42 in the lateral directions (i.e., along the “y-axis” of FIG. 6).

The cleats 44, when in place and secured to the covered carriage transport cart 40, retains the cover portion 42 to the carriage portion 22 and restricts vertical motion (i.e., along the “z-axis” of FIG. 6).

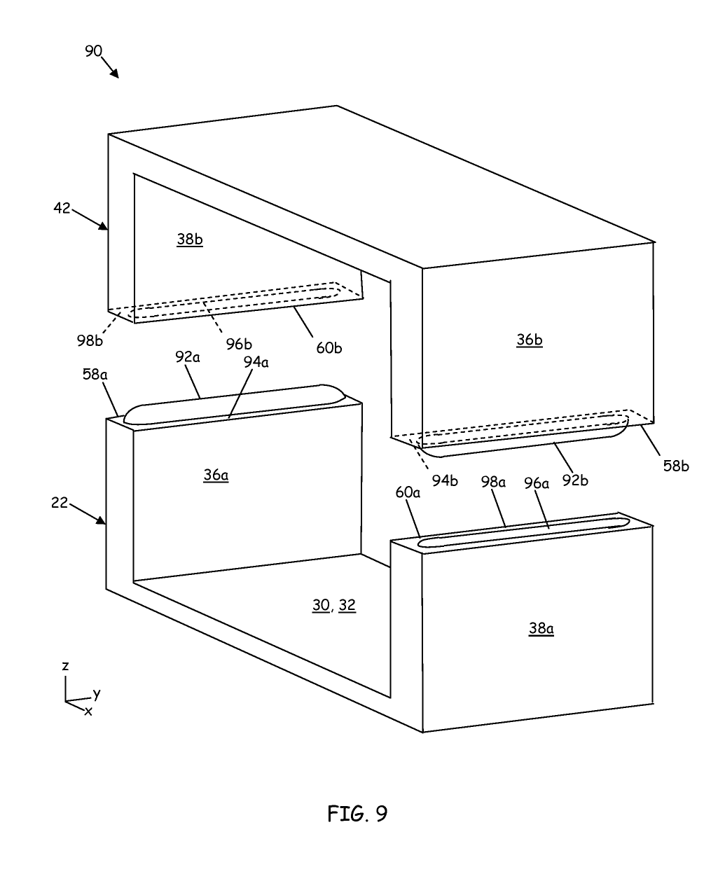

Referring to FIG. 9, another example of a covered carriage assembly 90 having carriage and cover portions 22 and 42 that are identically formed and include complementary structure is depicted in an embodiment of the invention. In this example, the first end wall portions 36a and 36b each include an oblong protrusion 92a and 92b, respectively, at the distal ends 58a and 58b, respectively. The oblong protrusions 92a and 92b each extend partially along the width of the respective end wall portions 36a and 36b. In the depicted embodiment, each protrusion 92a and 92b stand proud above a respective shoulder portion 94a and 94b. The second end wall portions 38a and 38b can each include a respective recess 96a and 96b on the end distal end portions 60a and 60b, the recesses 96a and 96b being dimensioned to accept the respective one of the oblong protrusions 92a and 92b. In the depicted embodiment, each recess 96a and 96b is recessed relative to a respective distal surface 98a or 98b. The shoulder portions 94a and 94b and the distal surfaces 96a and 96b can be substantially planar (as depicted) or, alternatively, can include profiles or additional structure that are complementary.

In assembly, the cover portion 42 is coupled to the carriage portion 22 so that the oblong protrusions 92a and 92b are inserted into the recesses 96b and 96a, respectively so that the shoulder portions 94a and 94b register against distal surfaces 96b and 96a, respectively. The carriage and cover portions 22 and 42 are thereby interlocked to inhibit relative motion therebetween parallel to the x-y plane (see coordinate system in FIG. 9).

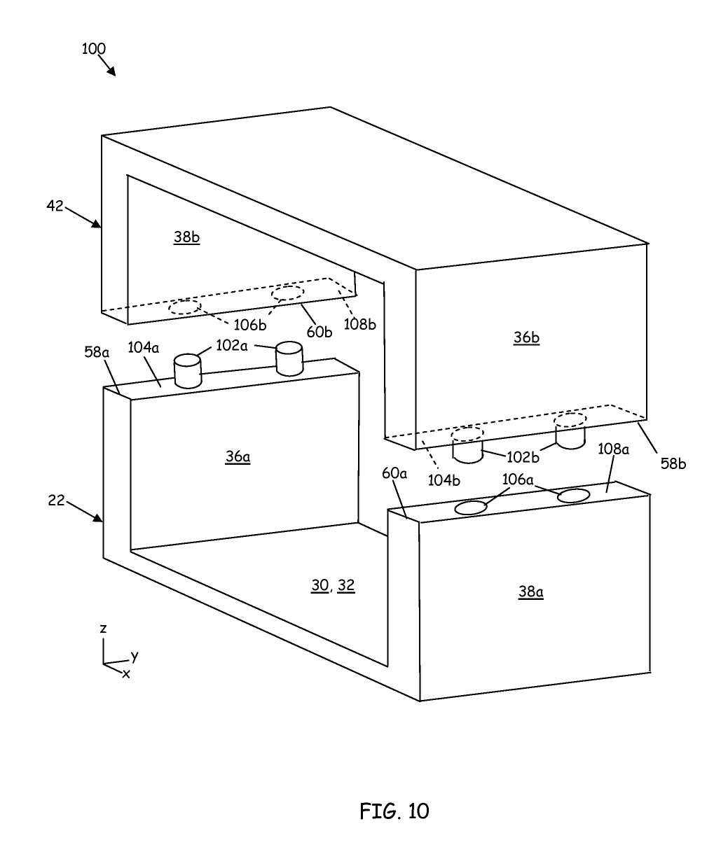

Referring to FIG. 10, still another example of a covered carriage assembly 100 having carriage and cover portions 22 and 42 that are identically formed and include complementary structure is depicted in an embodiment of the invention. In this embodiment, the first end wall portions 36a and 36b include a plurality of posts 102a and 102b, respectively, integrally formed on the distal ends 58a and 58b, respectively. The plurality of posts 102a and 102b stand proud above a respective shoulder portion 104a and 104b. The second end wall portions 38a and 38b can each include a respective plurality of recesses 106a and 106b on the end distal end portions 60a and 60b, the recesses 106a and 106b being dimensioned to accept the respective one of the plurality of posts 102a and 102b. In the depicted embodiment, each recess of the plurality of recesses 106a and 106b is recessed relative to a respective distal surface 108a or 108b. The shoulder portions 104a and 104b and the distal surfaces 106a and 106b can be substantially planar (as depicted) or, alternatively, can include profiles or additional structure that are complementary.

In assembly, the cover portion 42 is coupled to the carriage portion 22 so that the plurality of posts 102a and 102b are inserted into the plurality recesses 106b and 106a, respectively so that the shoulder portions 104a and 104b register against distal surfaces 106b and 106a, respectively. The carriage and cover portions 22 and 42 are thereby interlocked to inhibit relative motion therebetween parallel to the x-y plane (see coordinate system in FIG. 10).

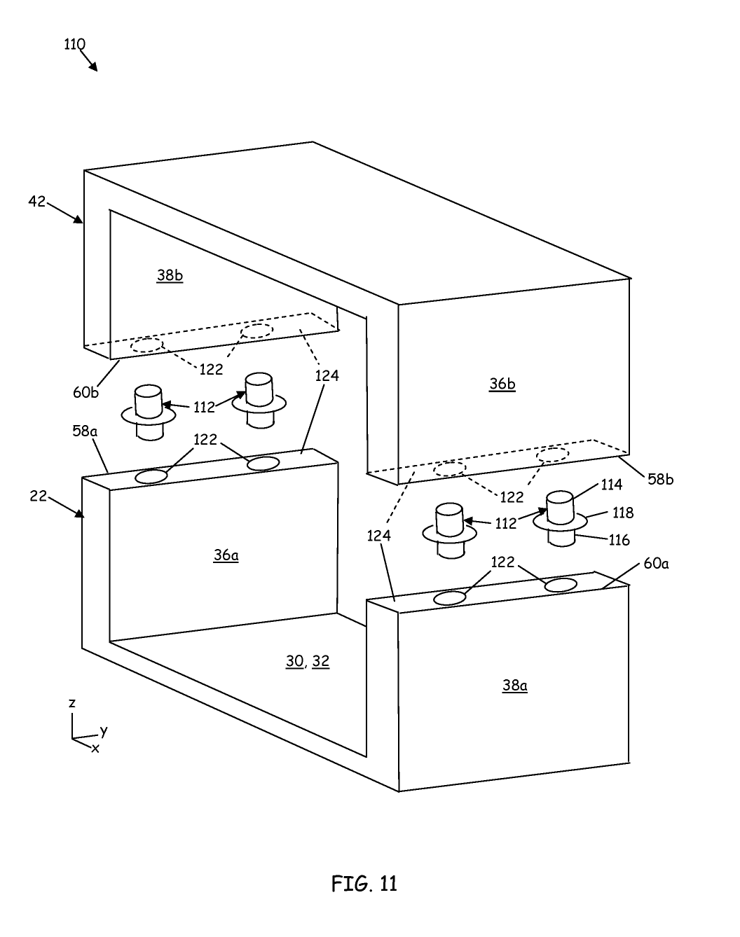

Referring to FIG. 11, a covered carriage assembly 110 having carriage and cover portions 22 and 42 that are identically formed but not complementary are depicted in an embodiment of the invention. In this embodiment, additional coupling structure is needed to provide an interlock between the carriage and cover portions 22 and 42. That coupling structure can take the form of flanged posts 112, each having a lower portion 114 and an upper portion 116 separated by a flange portion 118, as depicted in FIG. 11. The flanged posts are formed separately from the carriage and cover portions 22 and 42.

For the covered carriage assembly 110, all end wall portions 36a, 38a and 36b, 38b include a plurality of recesses 122 on the end distal end portions 60a and 60b, the recesses 122 being dimensioned to accept the respective one of the plurality of flanged posts 112. In the depicted embodiment, each recess of the plurality of recesses 122 is recessed relative to a distal surface 124, which can be substantially planar.

In assembly, the flanged posts 112 can be inserted into various of the plurality of recesses 122 so that one of the upper or lower portions 114 or 116 are proud relative respective distal surface 124. The flanged posts 112 can all be inserted into the carriage portion 22 or all inserted into the cover portion 42. Alternatively, some of the flanged posts 112 can be inserted into the carriage portion 22 and some into the cover portion 42, so long as the recess 122 that mates with the flanged post 122 during placement of the cover portion 42 onto the carriage portion 22 remains open.

The flanged posts 112 are examples of an “interlocking coupling structure” that interlocks the cover portion 42 and the carriage portion 22 and are separate from the cover and carriage portions 42 and 22. The cover portion 42 is coupled to the carriage portion 22 so that the flanged posts 112, previously disposed within the various recesses 122, are mated with the plurality recesses 122 that are unoccupied, so that the distal surfaces 124 of both the carriage portion 22 and the cover portion 42 are in contact with the flange portions 118 of the flanged posts 112. The carriage and cover portions 22 and 42 are thereby interlocked to inhibit relative motion therebetween parallel to the x-y plane (see coordinate system in FIG. 11).

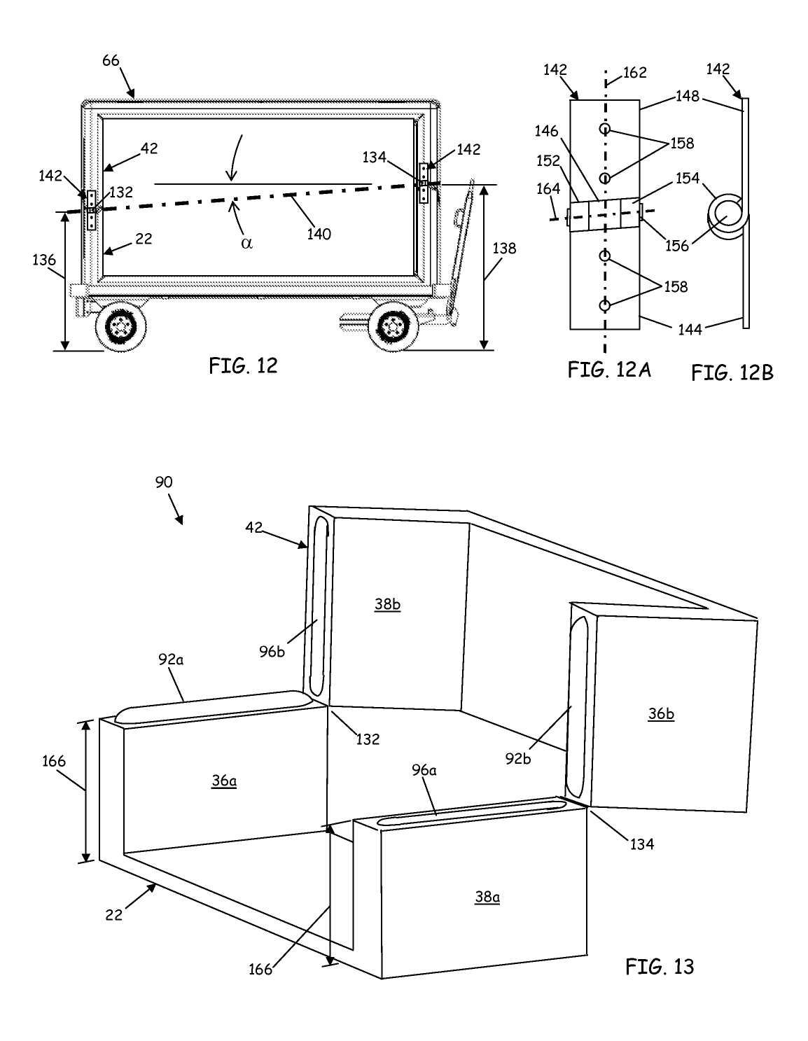

Referring to FIGS. 12 and 13, the covered carriage configurations 66 and 90 are depicted, respectively, with the cover portions being hinged, in embodiments of the invention. The hinged configurations enable the covered portion 42 to be swung away for increased access to the carriage portion 22.

For the covered carriage 66, hinge points 132 and 134 are at different elevations 136 and 138. In such a circumstance, it is preferred that the cover portion 42 pivot about a non-horizontal hinge axis 140 that passes through the hinge points 132 and 134, so that the covered portion 42 swings away from the carriage portion 22 without imparting undue stress on the hinge hardware or the portions of the covered carriage 66 to which the hinge hardware is mounted. The non-horizontal hinge axis 140 can be characterized as defining an angle α relative to horizontal.

In one embodiment, an angled hinge 142 (FIGS. 12A and 12B) can be implemented to better facilitate hinging about the non-horizontal hinge axis 140. The angled hinge 142 includes a first wing portion 144 having a central knuckle 146 and a second wing portion 148 having two side knuckles 152 and 154, the wings 144 and 148 being connected by a pin 156. Through holes 158 are formed in both the first and second wing portions 144 and 148 and lie substantially along a mounting axis 162 for fastening the wing portions 144 and 148 to the cover and carriage portions 42 and 22, respectively. The knuckles 146, 152 and 154 are formed so that when co joined by pin 156, an angled hinge axis 164 is defined that is not perpendicular and corresponds to the angle α of the non-horizontal hinge axis 140.

The embodiment of FIG. 13 depicts the hinge points 132 and 134 at an elevation 166 referenced to horizontal. Angled hinges provide no advantage for such embodiments.

While the complementary structures depicted herein provides for positive interlock between the components, such interlocking itself may not always be sufficient to secure the carriage and cover portions 22 and 42 together during the rigors of operation. Accordingly, the carriage and cover portions 22 and 42 can be additionally secured with external fastening assemblies, such as the fastening cleats 44 and brackets 78 of the covered carriage transport cart 40. By this arrangement, relative movement between the carriage and cover portions 22 and 42 are restricted in the vertical direction (i.e., along the “z-axis” of FIG. 1).

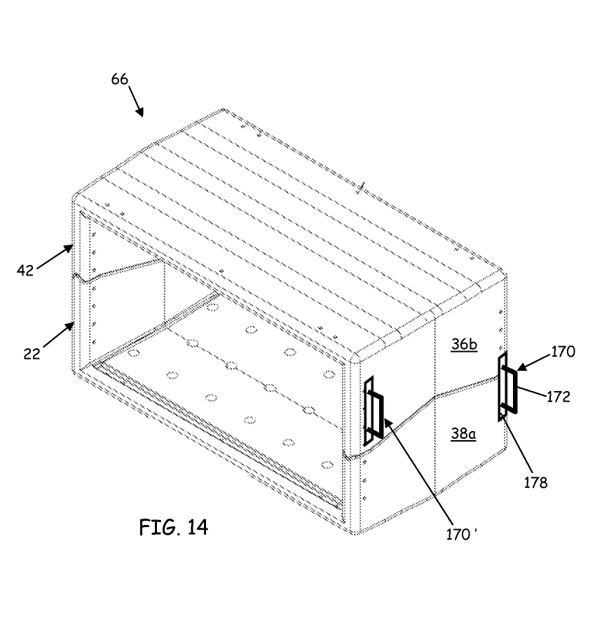

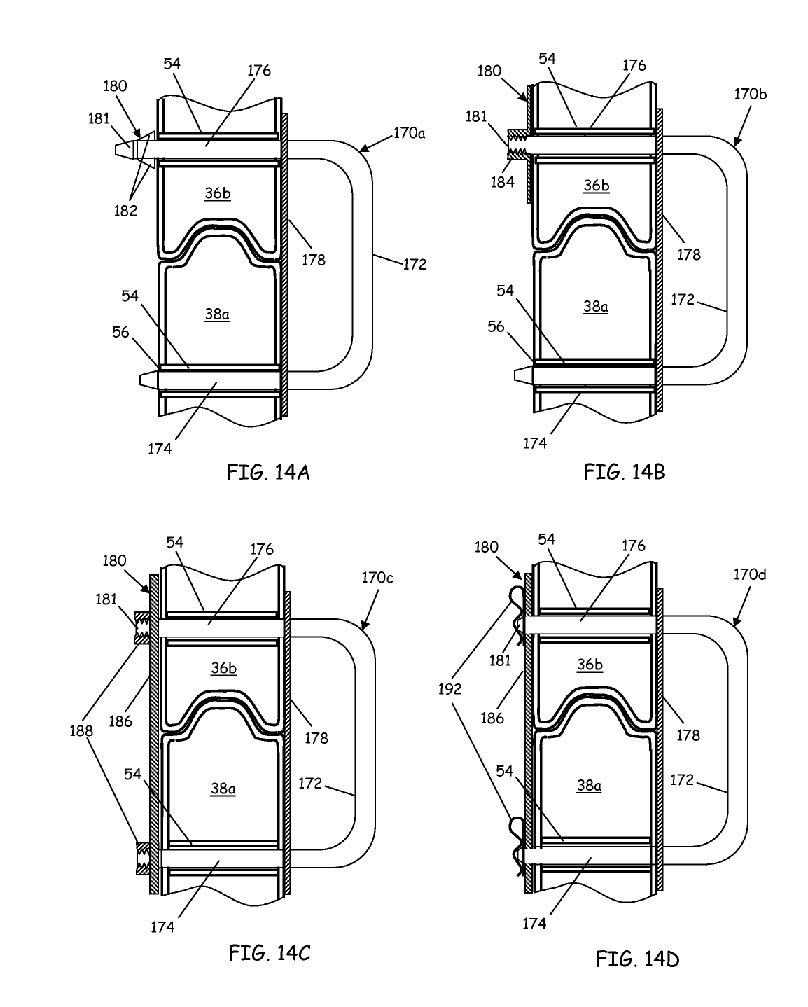

Referring to FIGS. 14 and 14A through 14D, other means for securing the cover portion 42 to the carriage portion 22 can be utilized. In one embodiment, and using the covered carriage 66 as an example, a removable handle 170 is be implemented. The removable handles 170 can include a handle portion 172 with prong portions 174 and 176 that extend through a flange portion 178. At least one of the prong portions 176 includes a clasping means 180 at a distal end 181 distal to the handle portion 172.

To implement the removable handles 170, the prong portion 174 of the handle portion 172 is inserted into one of the passageways 56 (FIG. 6) on the carriage portion 22 and the prong portion 176 is inserted into one of the passageways 56 on the cover portion 42. The clasping means 180 is then deployed to capture the abutting end walls, e.g., end walls 36b and 38a in the depictions of FIG. 14. The abutting end walls (e.g., 36b and 38a) are thus captured in relation to each other so that vertical movement therebetween is restricted. The removable handle 170 is secured to the covered carriage 66 by the capture of the end wall 36b between the clasping means 180 and the flange portion 178.

Referring to FIG. 14A, a removable handle 170a is depicted with retractable claws 182 as the clasping means 180. In the depicted embodiment, the prong portion 176 extends through the thickness of the end wall 36b via the molded tube 54 of one of the passageways 56 so that the claws 182 deploy against the interior surface of the end wall 36. The claws 182 are biased in the outward or deployed position, but retract inward when pushed through the passageway 56. Once the claws 182 pass through the passageway 56, they deploy outward to effectively clasp prong portion 176 between the claws 182 and the flange portion 178 of the removable handle 170a.

The prong portion 174 can, but need not, include a clasping means. Because of the various structures that retain the cover portion 42 and the carriage portion 22 in a fixed relationship on the x-y plane, a single clasping means 180 on the prong portion 176 only will suffice. Accordingly, in the depicted embodiment, the prong portion 174 of the removable handle 170a does not have a clasping means. While the prong portion 174 is depicted as extending all the way through one of the passageways 56 that are on the end wall 38a, the prong portion 174 need only extend partway into the passageway 56.

To remove the removable handle 170a, an operator retracts the claws 182 by manually squeezing the claws 182 inward to be within the diameter of the passageway 56, then pulls the removable handle 170a outward.

Other examples of clasping means 180 include a threaded washer 184 threadably engaged with the prong portion 176 (FIG. 14B), a plate 186 secured to the prong portions 174 and 176 by fasteners 188 that threadably engage with the prong portions 174, 176 (FIG. 14C), or the plate 186 being secured to the prong portions 174 and 176 by cotter pins 192 (FIG. 14D).

Functionally, each of the removable handles 170a-170d (referred to collectively as removable handles 170) of FIG. 14 perform the same function: securing abutting end wall portions against each other (e.g., 36a to 38b or 38a to 36b). The removable handles 170 provide the advantage of rapid deployment. That is, the cover portion 42 can be quickly added to or removed from to the carriage assembly use of the removable handles 180 at all four corners of a given carriage assembly. This enables ready conversion from the open carriage configuration to the closed carriage configuration.

For embodiments utilizing a hinged cover portion, removable handles 170 located on the side of the covered carriage opposite the hinges can serve as latches that hold the hinged cover portion closed.

Also, when the removable handles 170 are not retaining use, they can be stowed with the cover portion 42. As depicted in FIG. 14, removable handle 170′ is coupled with unoccupied passageways 56 of the end wall 36b only. In this way, the removable handle 170′ is stowed with the cover portion 42, and can be used for easier handling of the cover portion 42.

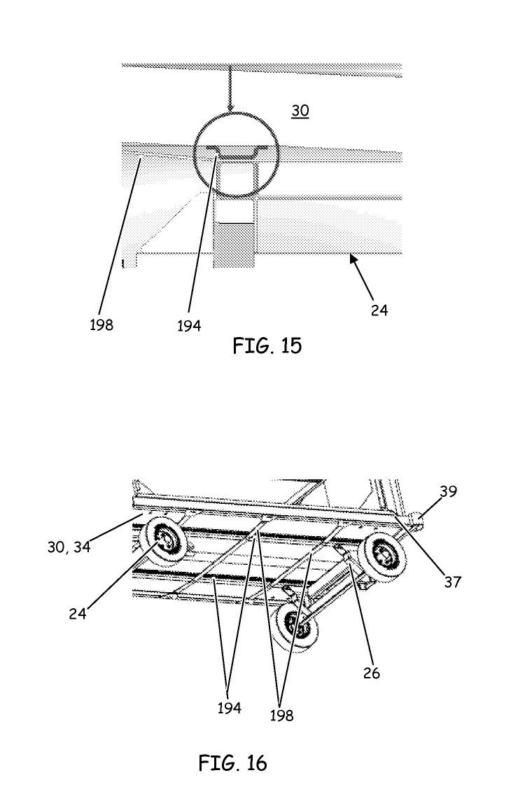

Referring to FIGS. 15 and 16, details are provided regarding the undercarriage of the various transport carts (e.g., 20, 40 and 70) in an embodiment of the invention. In one embodiment, the front and back wheel assemblies 24 and 26 are independent. In the depicted embodiment, a pair of strengthening ribs 194 extends lengthwise along the second major surface 34 of the span portion 30, and the front and back wheel assemblies 24 and 26 can be mounted to the strengthening ribs 194. A plurality of band straps 198 can extend across the frame 37 and under the strengthening ribs 194.

Functionally, the band straps 198 can add to the rigidity or stiffness of the strengthening ribs 194. When tightened, the band straps 198 provide support for the strengthening ribs 194 to help give the span portion 30 rigidity.

All of the features disclosed in this specification (including any accompanying claims, abstract and drawings), and/or all of the steps of any method or process so disclosed, can be combined in any combination, except combinations where at least some of such features and/or steps are mutually exclusive.

Each feature disclosed in this specification (including any accompanying claims, abstract and drawings) can be replaced by alternative features serving the same, equivalent or similar purpose, unless expressly stated otherwise. Thus, unless expressly stated otherwise, each feature disclosed is one example only of a generic series of equivalent or similar features.

For purposes of interpreting the claims for the present invention, it is expressly intended that the provisions of Section 112, sixth paragraph of 35 U.S.C. are not to be invoked unless the specific terms “means for” or “step for” are recited in the subject claim.

What is claimed is:

1. A transport trailer, comprising:
a cover portion;
a carriage portion operatively coupled with said cover portion;
a front wheel assembly operatively coupled with said carriage portion;
a back wheel assembly operatively coupled with said carriage portion,
said carriage portion and said cover portion each including a span portion integrally formed with two opposing end wall portions, each of said end wall portions extending perpendicular to said span portion from a respective end of said span portion, each of said end wall portions including a distal end face distal to said span portion, said span portion and opposing end wall portions being integrally formed and of a polymer material,
wherein said cover portion is in an inverted orientation relative to said carriage portion so that said distal end faces of said end wall portions of said cover portion are adjacent said distal end faces of said end wall portions of said carriage portion,
wherein said cover portion and said carriage portion are identically formed.

2. The transport trailer of claim 1, wherein said distal end faces of said end wall portions of said cover portion and said distal end faces of said end wall portions of said carriage portion each include complementary structure that interlocks, said complementary structure being integrally formed with said cover portion and said carriage portion.

3. The transport trailer of claim 1, wherein said cover portion and said carriage portion are rotationally molded components.

4. The transport trailer of claim 1, further comprising interlocking coupling structure that mates with both said cover portion and said carriage portion, said interlocking coupling structure being separate from said cover portion and said carriage portion, said interlocking coupling structure restricting relative motion between said cover portion and said carriage portion in a horizontal plane.

5. The transport trailer of claim 1, further comprising means for securing said cover portion to said carriage portion and restricting relative motion between said cover portion and said carriage portion in a vertical direction.

6. The transport trailer of claim 5, wherein said means for securing said cover portion to said carriage portion comprises fastening cleats mounted on a vertical face of said adjacent end wall portions to bridge said distal end faces of the adjacent end wall portions of said carriage portion and said cover portion, said fastening cleats being coupled with the adjacent end wall portions with fasteners.

7. The transport trailer of claim 5, wherein said means for securing said cover portion to said carriage portion comprises a removable handle.

8. The transport trailer of claim 1, wherein said cover portion is coupled with said carriage portion with hinges.

9. The transport trailer of claim 8, wherein said hinges are angled hinges to accommodate a non-horizontal hinge axis.

10. A method of making a transport trailer, comprising:
providing a carriage portion and a cover portion that are identically formed and each including a span portion integrally formed with two opposing end wall portions, each of said end wall portions extending perpendicular to said span portion from a respective end of said span portion, each of said end wall portions including a distal end face distal to said span portion;
inverting said cover portion relative to said carriage portion;
positioning said cover portion relative to said carriage portion so that said distal end faces of said end wall portion of said cover portion are adjacent said distal end faces of said end wall portion of said carriage portion; and
coupling said cover portion to said carriage portion.

11. The method of claim 10, further comprising:
providing a front wheel assembly and a back wheel assembly; and
operatively coupling said front wheel assembly and said back wheel assembly to said carriage portion.

12. The method of claim 10, wherein the step of coupling said cover portion to said carriage portion includes:
providing a coupling structure separately formed from said cover portion and said carriage portion;
disposing said coupling structure between the adjacent of said distal end faces of said end wall portions of said carriage portion and said cover portion,
said coupling structure restricting relative motion between said cover portion and said carriage portion in a horizontal plane.

13. The method of claim 10, wherein said distal end faces of said carriage portion and said cover portion provided in said step of providing includes complementary structure that interlocks, said complementary structure being integrally formed with said cover portion and said carriage portion.

14. The method of claim 10, further comprising:
providing a pair of hinges; and
hingeably attaching said cover portion to said carriage portion with said pair of hinges.

15. The method of claim 14, wherein said hinges provided in the step of providing said pair of hinges comprise angled hinges to accommodate a non-horizontal hinge axis.

16. The method of claim 10, further comprising securing said cover portion to said carriage portion with structure mounted on a vertical face of said adjacent end wall portions to bridge said distal end faces of the adjacent end wall portions of said carriage portion and said cover portion.

17. The method of claim 16, wherein said structure mounted on said vertical face in the step of securing said cover portion to said carriage portion comprises a fastening cleat.
